(19) United States
(12) Patent Application Publication
(10) Pub. No.: US 2026/0154970 A1
(43) Pub. Date: Jun. 4, 2026

(54) OBJECT DETECTION

(71) Applicant: Zoox, Inc., Foster City, CA (US)

(72) Inventors: Venkata Subrahmanyam Chandra Sekhar CHEBIYYAM, Mountain View, CA (US); Aurora Linh EVERGREEN, San Mateo, CA (US); Hemant HARI KUMAR, San Mateo, CA (US); Yashwanth KONDURI, San Francisco, CA (US); Adhitya POLAVARAM, Ithaca, NY (US); Abhinav PRASAD, Mountain View, CA (US); Shaminda SUBASINGHA, San Ramon, CA (US); Sivaramakrishnan SUBRAMANIAN, San Mateo, CA (US); John Welling WARE, Cambridge, MA (US); Xuan ZHONG, San Jose, CA (US); Xin Geng KELLY, Las Vegas, NV (US)

(21) Appl. No.: 18/965,464

(22) Filed: Dec. 2, 2024

(51) Int. Cl. G06V 20/58; B60W 60/00; G06V 10/774; G06V 10/82; G06V 20/70

(52) U.S. Cl. CPC G06V 20/58; B60W 60/001; G06V 10/774; G06V 20/70; B60W 2420/403; B60W 2554/402; G06V 10/82; G06V 2201/08

(57) ABSTRACT

Systems, methods and non-transitory computer-readable media are presented. These describe operations comprising obtaining, visual data acquired by a first image sensor and associated with a traffic scene and obtaining, audio data acquired by a first audio sensor and associated with the traffic scene. The first audio sensor and the first image sensor are mutually independent. The operations further comprise determining, based at least in part on the visual data and the audio data, embeddings for the traffic scene that represent a joint representation space for the different modalities; and determining, by a first machine learning model, and based at least in part on the embeddings, presence of an emergency vehicle in the traffic scene.

### BACKGROUND

Object detection in autonomous vehicles is an important function that enables the vehicle to recognize and interpret its surroundings. The process generally involves identifying various objects on or at the road, such as pedestrians, vehicles, cyclists, road signs, and other obstacles, and understanding their location, movement, and potential risks.

### BRIEF DESCRIPTION OF DRAWINGS

The detailed description is described with reference to the accompanying figures. The use of the same reference numbers in different figures indicates similar or identical components or features.

FIG. 1 is a pictorial diagram illustrating an example implementation for determining presence of emergency vehicles in a traffic scene, in accordance with examples of the disclosure.

FIG. 2 is a pictorial diagram illustrating an example implementation of an early fusion machine learning model for detecting specific objects, in accordance with examples of the disclosure.

FIG. 3 is a schematic view illustrating an example implementation of a system for detecting specific objects, in accordance with examples of the disclosure.

FIG. 4 is a flow chart view illustrating an example implementation of a process for detecting specific objects, in accordance with examples of the disclosure.

FIG. 5 is a flow chart view illustrating an example implementation of a process for detecting emergency vehicles in a traffic scene, in accordance with examples of the disclosure.

FIG. 6 depicts a block diagram of an example system for implementing the techniques described herein.

### DETAILED DESCRIPTION

The task of object detection in autonomous vehicles (AVs) may be provided through an integration of multiple sensors of the AVs, sensors such as cameras, radar, lidar, etc. that capture different types of environmental data describing surroundings of the AV. Cameras may provide visual information, radar may offer distance and speed data, and lidar may supply 3D maps of the vehicle's surroundings. This senor data enables the AV to detect and classify objects in its environment.

The sensor data may be provided to machine learning (ML) models configured to detect and classify objects in real-time. ML is a field within artificial intelligence that focuses on developing algorithms that enables systems to learn patterns from data and make predictions or decisions without being explicitly programmed. In traditional programming, rules and logic are manually defined by developers to process data and produce outcomes. In machine learning, the model “learns” these rules by finding patterns in data, adapting over time to improve its accuracy as it's exposed to more information. Deep learning algorithms, such as convolutional neural networks (CNNs), transformer-based models, etc., may be configured to process sensor data and provide robust and reliable object detection systems. These algorithms are generally trained on vast datasets of ground truth data comprising labeled images and sensor readings accurately identifying objects in diverse conditions such as during different lighting, weather, an/or traffic scenarios. Continuously detecting and tracking of objects is important for an AV to make informed decisions about path planning, speed control, and/or obstacle avoidance to e.g., ensure safe and efficient navigation.

An AV may combine detections from different, independent sensors, to determine presence of specific objects. For instance, the AV may be configured to detect presence of emergency vehicles in the environment based on audio and video data. The audio data may be processed to determine if any audio indicating presence of an emergency vehicle is captured. In parallel, or substantially in parallel, the video data may be processed to determine if any visual que indicating presence of an emergency vehicle is captured. Determining whether there is an emergency vehicle in the environment may be based on combining the results from the processing of the audio and the processing of the video. However, this approach may be prone to errors. An emergency vehicle may be visible even if it not heard, the sirens may for instance be muted. Further to this, an emergency vehicle may be heard even if it is not visible, the vehicle may be occluded by objects such as vehicles, buildings, etc. Even if the respective results may be paired with a level of certainly provided by each processing, the detection may be prone to errors, both false positives and false negatives. In a context of machine learning (ML), this approach may be referred to as a late fusion approach for combining vision and audio data. Late fusion involves using disparate model architectures for each modality and then combining the outputs with certain cost functions.

Modality, as used herein, refers to a specific type or form of sensory data or input channel. For an AV, a plurality of data modalities are generally available. Visual data from cameras provides detailed information about the surroundings, and may be configured to capture e.g., color, texture, and shape of objects, which helps in identifying road signs, lane markings, traffic lights, pedestrians, etc. A Light Detection and Ranging (Lidar) device emits laser pulses to produce a high-precision 3D point cloud, Lidar data, providing comparably accurate depth and distance measurements. This modality is generally effective for mapping the environment in three dimensions, aiding in obstacle detection and assessing the size and distance of objects. A Radar device, providing radar data, using radio waves to detect the position and speed of objects, may be useful for tracking other vehicles and estimating their velocities. Radar sensors are comparably resilient to various weather conditions, including rain, fog, and snow, and they are less affected by lighting. Ultrasonic sensors, which emit sound waves, may be provided for detecting objects comparably close to the AV. They are particularly effective at low speeds and in parking scenarios, identifying nearby obstacles such as curbs or other vehicles. Global Positioning System data (GPS data) may provide a global position of the vehicle, useful for supporting route planning and navigation. When combined with high-definition maps, GPS enables accurate localization within the environment. An Inertial Measurement Unit (IMU) may offer data (IMU data) indicating acceleration and/or angular velocity, assisting in tracking movements, orientation, and/or tilt of the AV. This information may be provided to assist in stabilizing vehicle control and may enhance positional accuracy using e.g., dead reckoning, especially when e.g., GPS signals are weak or unavailable. Further to this, audio data may be provided to enable the AV to recognize events or hazards that may not be immediately visible, such as emergency vehicle sirens, honking horns, trains, or other auditory cues indicating potential road activity.

Embeddings in machine learning are generally compact, dense vector representations of complex data that capture essential information in a form that is easier for models to work with. For example, humans generally process high-dimensional, unstructured data such as text, images, or audio. This high-dimensional data, as such, is generally challenging for ML models to understand and identify patterns in. Embeddings are provided to transform this high-dimensional data into lower-dimensional representations, generally as arrays of numbers (vectors), that encode (indicate, describe) relationships and features within the data. For example, in natural language processing, word embeddings convert words into vectors such that words with similar meanings have similar vectors. This means that “dog” and “puppy” may have vectors close to each other, while “dog” and “car” would be farther apart. Embeddings in this case capture the semantic meaning and context of words, which helps models understand language more intuitively, allowing them to perform tasks like sentiment analysis, translation, or text generation more effectively. Correspondingly, for images, embeddings represent visual data by extracting features like color, shape, and texture. With image embeddings, ML models may then perform tasks like classification (e.g., identifying an object as a car or dog) or similarity search (finding images that resemble each other). Embeddings are generally produced by an encoder component of the ML model. The encodes is trained to distill the raw input data into the embeddings, i.e., for the ML model meaningful, compressed representations. An encoding process generally involves training the ML model on large datasets to capture patterns that reflect similarities and distinctions within the data. This process is sometimes referred to as feature extraction. Once learned, these embeddings are comparably compact and efficient to store and compute with, making them practical for real-time applications.

An ML model trained to detect emergency vehicles from audio data, will generally be configured with an encoder trained on ground truth data where audio data comprising sounds of emergency vehicles, audible ques (i.e., sirens), is labeled as being data having characteristics that should be detected by the ML model. Correspondingly, ground truth data not comprising emergency vehicles is labeled as being data not having characteristics that should be detected by the ML model. Embeddings provided by the encoder will categorize audio data comprising characteristics similar to sirens as audio data potentially describing an emergency vehicle. This means that audio data comprising loud, attention-grabbing audio having characteristics such as oscillating tones, high frequencies, and/or repetitive patterns is likely to have vectors similar to audio data comprising emergency vehicles. Such audio may originate from building alarm systems, car alarms, too, industrial warning signals, such as those used at construction sites or on large machinery, air raid sirens, musical instruments, etc.

Correspondingly, an ML model trained to detect emergency vehicles from video data, will generally be configured with an encoder trained on ground truth data where video data comprising visual ques of emergency vehicles (i.e., vehicles with specific colors, visible sirens, etc.) is labeled as being data having characteristics that should be detected by the ML model. Correspondingly, ground truth data not comprising emergency vehicles is labeled as being data not having characteristics that should be detected by the ML model. Embeddings provided by the encoder will categorize video data comprising characteristics similar to sirens as video data potentially describing an emergency vehicle. This means that video data comprising visual ques exhibiting flashing lights, high-contrast colors, lettering such is likely to have vectors similar to video data comprising emergency vehicles. Such video data may originate from construction vehicles having flashing lights, safety vests, traffic cones, barricades, etc., where bright, reflective colors are combined with stripes or other bold patterns to increase visibility or vehicles, barriers, etc., having large bold lettering such as “CAUTION” or “DANGER”.

The ground truth data for training a ML model, or an encoder of an ML model, is generally provided by manual labeling of data, i.e., by humans listening to audio to determine if there are sirens audible or not in the data. Manual labeling is a time consuming and comparably expensive manner of providing ground truth data where a person, an annotator, reviews and labels each sample of raw data according to predefined categories or attributes. For example, annotators may label images with bounding boxes around objects (like “car” or “pedestrian”) in object detection tasks, or they might categorize text by sentiment (positive, neutral, or negative) in natural language processing. Manual labeling may be provided by specialized labeling companies, where large teams work to label vast datasets to ensure accuracy and consistency.

The present disclosure is concerned with increasing accuracy and/or reliability of detection of objects being detectable by more than one modality. As mentioned, an emergency vehicle may be detected by either its distinctive sound, or by its distinctive visual appearance. By combining data of different modalities in a multimodal detector, i.e., a detector having a shared representation space, a number of false positive detections and false negative detections may be reduced compared to a late fusion detector. The multimodal detector may be described as an early fusion model where inputs to the ML model are of different modalities, such as an audio input and a video input. This means that embeddings determined by the early fusion model are shared between the modalities.

In one example, a system is configured to obtain visual data acquired by a first image sensor and associated with a traffic scene and audio data acquired by a first audio sensor and associated with the traffic scene. The first audio sensor and the first optical sensor are mutually independent.

The image sensor may be any suitable image sensor and may be configured to form part of an imaging device such as a digital camera. The image sensor may be exemplified by, but not limited to a CMOS sensor, a CCD sensor, an IR sensor, an RGB-IR sensor etc. The visual data may be visual data in any suitable form such as raw image data or processed image data. Raw image data generally refers to an unprocessed output directly from an optical sensor. The raw image data captures substantially all information that the optical detects such as color values, brightness, etc. Raw image data preserve the highest quality and generally contain more bit depth, which means they have a wider range of color and light information compared to standard images. Examples of raw image data formats are RAW, NEF, etc. Processed, or compressed image data, on the other hand, undergoes processing, generally to reduce file size and/or apply specific filtering. Compression may be provided by eliminating or reducing redundant or less important information in the image data. Some compression is substantially lossless, as seen in formats like PNG or TIFF, which reduces the size of the image data without substantially sacrificing any image quality. The visual data may, in some examples, be video data in any suitable form or format such as a lossy format exemplified by, but not limited to, MP4, AVI (older versions), MKV, WebM, etc., or a lossless format exemplified by, but not limited to, AVI (uncompressed), MOV, FFV1, etc.

The audio sensor may be any suitable audio sensor and may be configured to form part of an audio sensing device. The audio sensor may be exemplified by, but not limited to a dynamic microphone, a condenser microphone, a microelectromechanical systems (MEMS) microphone, a general acoustic pressure sensors, etc. The audio data may be audio data in any suitable form or format such as a lossy format exemplified by, but not limited to MP3, AAC, OGG etc., or a lossless format exemplified by, but not limited to, WAV, FLAC, ALAC, AIFF etc.

Two sensors, such as a visual sensor and an audio sensor mounted on a vehicle, may be described as being mutually independent when each one operates separately, capturing and processing data from different aspects of the environment without relying on the other. A visual sensor, like a camera, captures images or video of the surroundings, focusing on visual cues such as shapes, colors, and movements within its field of view. It gathers spatial information from light, allowing it to detect objects, road signs, and traffic signals based purely on visual characteristics. This sensor is not affected by sound and functions independently by processing only the visual data it receives. An audio sensor, such as a microphone, captures sounds from the environment, focusing on auditory cues like sirens, horns, and engine noises. It analyzes sound waves and frequencies, which provide temporal data about events that might not be visible, such as approaching vehicles or emergency sirens from out of sight. The audio sensor functions independently of the visual data; it detects and interprets sounds based on changes in sound patterns and intensities, without requiring input from the visual sensor. Additionally, two sensors of a same modality may be described as being mutually independent based on similar examples. In some examples, two mutually independent sensors are mounted at different locations of a vehicle.

The present example further comprises determining, based at least in part on the visual data and the audio data, embeddings for the traffic scene that represent a joint representation space for the different modalities, and determining, by a first ML model, and based at least in part on the embeddings, presence of an emergency vehicle in the traffic scene. The first ML model may be referred to as an early fusion ML model.

As mentioned, the application of an early fusion ML model for detecting e.g., emergency vehicles, may increase an accuracy of detection compared to single modality or late fusion models. For example, when detecting specific objects, such as emergency vehicles, utilizing a single ML model that accepts both audio and video data offers advantages compared to employing two separate models for each modality whose outputs are later combined to determine presence of the specific object. A unified model is able to learn joint embeddings within a shared representation space, capturing the intricate relationships and correlations between ques of different modalities, e.g., audio and visual cues. Such an integrated approach enables the early fusion ML model to better understand how specific ques of a first modality, e.g., sounds, like sirens, align temporally and contextually with specific ques of a second modality, e.g., visual features such as flashing lights or distinctive vehicle shapes. By processing both modalities together, the early fusion ML model may leverage complementary information to make more accurate and robust decisions. For example, in situations where visual data is obscured due to poor lighting or weather conditions, the audio data can compensate by providing clear siren sounds. Conversely, in noisy environments where audio data may be unreliable, visual cues may guide the detection. Each modality has strengths that may support the other, potentially enhancing the overall analysis. When used together, the first modality may provide insights that clarify ambiguous information in the second modality, and vice versa. For instance, audio data may enrich interpretation of visual data by identifying unseen sound sources or providing temporal markers for specific events that are difficult to perceive visually. Similarly, visual may can strengthen audio analysis by localizing sources of sound and clarifying spatial contexts. This bidirectional enhancement allows the model to draw from a broader set of clues, leading to a more nuanced and resilient analysis, particularly in challenging or dynamic environments. The shared representation space enables the early fusion ML model to weigh and integrate these inputs effectively, whereby an overall performance of the model may be enhanced. In contrast, having two separate models means that each model creates its own embeddings in isolation, without considering the interplay between e.g., audio and video data during feature extraction. When their outputs are combined post-hoc, the opportunity to learn cross-modal features and dependencies is limited, leading to less effective detection. Additionally, the early fusion ML model may simplify the system architecture and may be optimized end-to-end. Joint training allows the early fusion ML model to adjust its parameters cohesively across both modalities, potentially reducing redundancy and improving computational efficiency. It can learn to focus on the most relevant features from each modality, enhancing its ability to generalize across different environments and conditions.

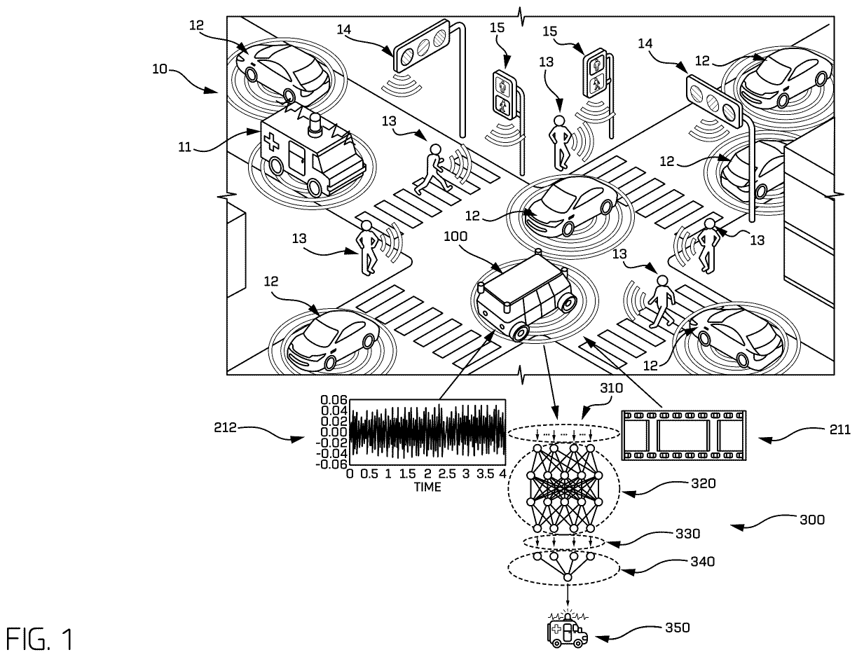

In FIG. 1, a view of a traffic scene 10 is shown. An AV 100 is navigating an intersection of the traffic scene 10. An emergency vehicle 11, an ambulance 11, is approaching the intersection and the AV 100 needs to accurately detect the approaching ambulance 11 in order to either stop or move out of the way and let the ambulance 11 pass. In addition to the AV 100 and the ambulance 11, the traffic scene 10 is composed of additional vehicles 12, pedestrians 13, traffic lights 14 and pedestrian crossing lights 15. The additional vehicles 12 are all making sounds, and they may be colored in distinct colors and/or labeled with distinctive text. The pedestrians 13 are listening to music, having conversations or making other sounds, and some pedestrians may be construction workers or safety aware citizens wearing reflective clothing. The traffic lights 14 and/or the pedestrian crossing lights 15 may be flashing and the pedestrian crossing lights 15 may make sounds to assist e.g., people with visual impairments.

In order to detect presence of the approaching ambulance 11, the AV 100 is configured with an early fusion ML model 300. The early fusion ML model 300 may be referred to as a first ML model. A sensor system of AV 100 is configured to provide the early fusion ML model 300 with visual data 211 and audio data 212 of the traffic scene 10. The early fusion model 300 accepts the visual data 211 and the audio data 212 as input data at an input 310 of the early fusion ML model 300. That is to say, the early fusion model 300 accepts data of different modalities as input data.

The input data may, if applicable, be synchronized, i.e., audio data 212 and visual data 211 in the form of video data 211 are in synch. Synchronized data refers to different types of data (same or different modalities) that are aligned in time, meaning that they are captured, processed, or presented in a way such that they at least substantially match the same temporal sequence. When audio data is synchronized with visual data, for example, every sound corresponds to the correct moment in the visual sequence. In some examples, wherein the visual data is non-moving visual data 211, such as still image data, a need for synchronization may be limited as there is no temporal aspect of still image data other than a time of capture. In such examples, it may be sufficient to provide image data 211 that is captured at some time during obtaining (sensing, recording, etc.) of the audio data 212, although a timestamping the audio data 212 with a capture time of the image data 211 may be advantageous.

The early fusion ML model 300 is, in FIG. 1, configured with an encoder 320. The encoder 320 may be an encoder 320 as introduced previously and may be any suitable encoder configured to handle the input data provided at the input 310 early fusion ML model 300. In some examples, the encoder 320 is an CNN encoder such as a 3D CNN, a recurrent neural network (RNN) encoder or a long short-term memory (LSTM) encoder. A CNN, is proficient at processing both spatial and temporal information, making them efficient for encoding sequences of frames for video data whilst RNN and LSTM encoders are generally designed to handle sequential dependencies, making them effective at tasks like language processing, time-series prediction, and speech recognition.

In some examples, the encoder 320 is a provided, at least partly, with a transformer architecture. The transformer architecture is described by Vaswani et al. in “Attention is All You Need”, NIPS 2017, which is hereby incorporated by reference in full and for all purposes. Generally, a transformer architecture is an architecture that may be configured to include an encoder alone or an encoder and a decoder. Models like bidirectional encoder representations from transformers (BERT, RoBERTa, and DistilBERT employ just an encoder stack. In these cases, the encoder layers focus on analyzing relationships within the input data, making the transformer act as an encoder-only model. Transformer-based models like generative pre-trained transformer (GPT) use only the decoder portion of the transformer architecture to generate output in a unidirectional manner, predicting the next element in a sequence based on previous elements. The original transformer model described in the article mentioned above and e.g., text-to-text transfer transformer (T5), are encoding and decoding based models. Encoding and decoding based models are used for e.g., sequence-to-sequence tasks like machine translation where the encoder processes and encodes the input data provided at the input 310 of the early fusion ML model 300 into a representation, which the decoder (classifier) 340 then uses to generate an output sequence, e.g., a prediction 350.

In some examples, the encoder 320 is provided, at least partly, with a variational autoencoder (VAE) architecture. VAEs are described by Kingma et al in “Auto-Encoding Variational Bayes”, 23 Dec. 2013, ICLR 2014 conference submission 2021 which is hereby incorporated by reference in full and for all purposes. VAEs are configured to handle different data types by using separate encoders for each modality, such as one encoder for images and another for audio. These encoders then combine the data into a shared latent space, a joint representation space, which makes VAEs effective at generating or reconstructing data across modalities

In some examples, the encoder 320 is a cross-modal encoder such as a contrastive language-image pretraining (CLIP) model. The CLIP model is described by Radford, A. et al in “Learning Transferable Visual Models From Natural Language Supervision”, Proceedings of the 38th International Conference on Machine Learning, 2021 which is hereby incorporated by reference in full and for all purposes. Cross modal encoders are generally designed to handle multimodal data by encoding and aligning features from different modalities within a shared representation space, a joint representation space.

In some examples, the encoder 320 comprises an audio transformer such as an audio spectrogram transformer, AST. ASTs are described by Gong et al in “AST: Audio Spectrogram Transformer”, Interspeech, 30 August-3 Sep, 2021, which is hereby incorporated by reference in full and for all purposes. Additionally, or alternatively, the encoder 320 may comprise an image transformer such as the transformer described by Dosovitskiy et al in “An Image is Worth 16×16 Words: Transformers for Image Recognition at Scale”, Published as a conference paper at ICLR 2021 which is hereby incorporated by reference in full and for all purposes.

As shown in FIG. 1, the encoder 320 provides embeddings 330 representing the input data provided at the input 310 of the early fusion ML model 300. As described, the embeddings 330 are generally, compared to the input data, low-dimensional data. For instance, assume a high-quality, 10 s video stream and a synchronized 10 s audio stream as input data 100 to a machine learning model 300. For the video stream, assume high-definition (1080p) video at 30 fps. In this example, each frame in this video has a resolution of 1920 by 1080 pixels, with each pixel typically represented by three color channels (RGB). This results in approximately 6.2 million values per frame (1920×1080×3). Over 10 seconds at 30 fps, this totals 300 frames, which means the entire video stream would comprise about 1.86 billion dimensions (or values). For the audio stream, using high-quality stereo sound at a 44.1 kHz sample rate and 16-bit depth (CD quality), each second equals to 44,100 samples per channel (right and left), resulting in 88,200 samples in total for stereo sound. With a 16-bit depth, each sample is represented by 2 bytes, leading to 176,400 bytes per second for audio. Over 10 seconds, this results in approximately 1.76 million dimensions (or values). Combining both, the input data would be represented by 1.86 billion dimensions (the audio data is neglectable in this example). The embeddings 330, the output from the encoder 320, significantly reduce the number of dimensions by capturing features from the input data that are deemed most important (from training). In some examples, dimensions of the embeddings 330 range from 128 to 2048 dimensions, depending on the complexity of the model and the task. In some examples, for multimodal models that process e.g., both audio and video, the modalities may be combined into a shared embedding space of e.g., 512 to 1024 dimensions in total. Compared to the input data, the embeddings 330 represent only the most relevant features, making the embeddings much more manageable while retaining important information for downstream tasks.

As indicated in FIG. 1, the embeddings 330 are provided to a classifier 340. The classifier 340 is a model or component within the early fusion ML model that makes predictions by categorizing data into predefined classes or labels. The classifier 340 obtains the embeddings 330 and assigns it to one of several possible categories based on patterns it has learned from training data. During training of the classifier 340, the classifier 340 is trained to recognize features or patterns associated with each category it is configured to identify by analyzing labeled examples in a dataset. For instance, in an image classification task to identify animals, the model is trained on labeled images of cats, dogs, and birds. The classifier 340 may be implemented using any suitable algorithm or model. In some examples, the classifier is based on logistic regression or decision trees. In some examples, being slightly more computational heavy, the classifier 340 may be based on deep learning approaches such as fully connected neural networks or CNNs. The classifier 340 generally operates by processing the embeddings 330 to make predictions 350 such as whether the input data provided at the input 310 of the early fusion ML model 300 comprises an emergency vehicle 11 or not.

In FIG. 1, the early fusion ML model 300 receives audio data 212 and video data 211 at the input 310 and provides a prediction 350 based on the input data 310. However, the early fusion ML model 300 may be configured to receive input data of only one modality and generate predictions 350 also based on this input data. In other words, the input data 310 is not required to be of more than one modality. That is to say, if the early fusion ML model 300 is configured to detect emergency vehicles 11 in a traffic scene 10, the early fusion ML model 300 will be able to do so even if e.g., audio data 212 or video data 211 is missing.

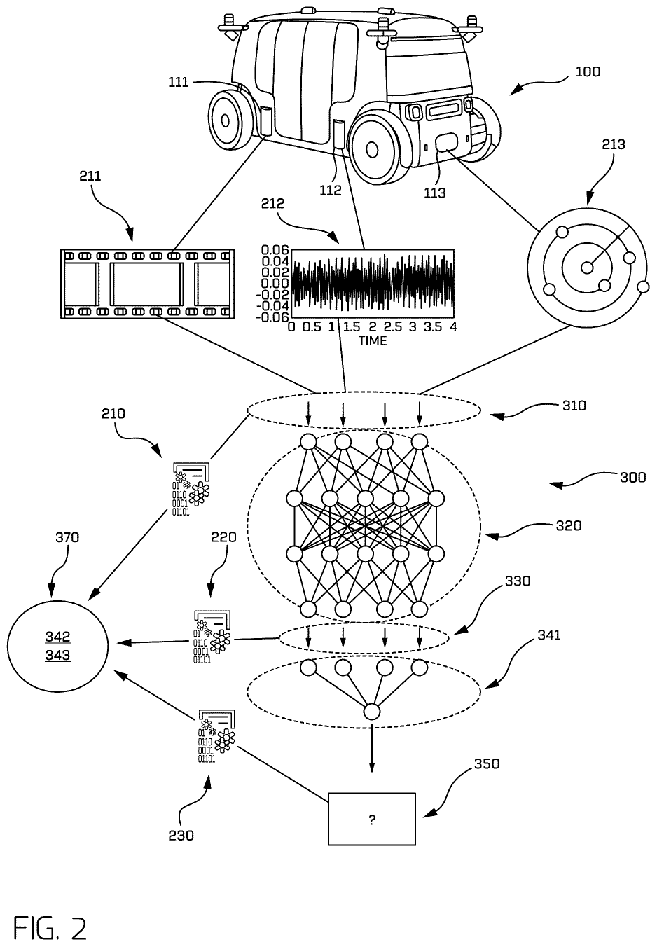

In FIG. 2, a schematic view of an AV 100 associated with the early fusion ML model 300 is shown. The AV 100 comprises sensors 111, 112, 113 of different modalities. In FIG. 2, the sensors 111, 112, 113 are exemplified by one or more visual sensors 111, one or more audio sensors 112 and one or more range sensors 113. The one or more visual sensors 211 are configured to detect, obtain or otherwise sense visual data 211 associated with an environment of the AV 100. The one or more audio sensors 112 are configured to detect, obtain or otherwise sense audio data 212 associated with an environment of the AV 100. The optional one or more range sensors 113 are configured to detect, obtain or otherwise sense range data 213 associated with an environment of the AV 100. At least one of the visual data 211, the audio data 212 or the range data 213 is provided as input data 210 at the input of the early fusion ML model 300, preferably, at least two of the visual data 211, the audio data 212 or the range data 213 are provided as input data 210 at the input of the early fusion ML model 300. The sensors 111, 112, 113 are generally independent, for instance, the range data 213 is provided by an independent range sensor 213 and is not determined by sensor fusion or processing of other sensor data 211, 212, 213 forming part of the input data 210.

The early fusion ML model 300 may, as described in reference to FIG. 1, be configured to provide predictions 350 based on the input data 210. However, seeing as the early fusion ML model 300 may be comparably complex, and computational heavy, especially the encoder 320 providing embeddings 330 of a joint representation space with different modalities, the early fusion ML model 300 may be utilized to label data for training one or more lightweight ML models 370. As used herein, a lightweight ML model 370 is an ML model with lower processing and/or storage requirements compared to the early fusion ML model 300. Lightweight ML models may be referred to herein as second ML model or third ML model. A lightweight ML model 370 may be an ML model that is configured to detect specific object in input data 210, but operates on one single modality input data 210, such as one of visual data 211, audio data 212 or range data 213. To this end, the prediction 350 determined by the early fusion ML model 300 may be provided as a prediction label 230. The prediction label 230 and its associated input data 210 constitutes labeled data that may be utilized as ground truth data for training lightweight ML models 370. That is to say, the prediction label together with the visual data 211 may be referred to as labeled visual data, the prediction label together with the audio data 212 may be referred to as labeled audio data, and the prediction label together with the range data 213 may be referred to as labeled range data.

In one example, the early fusion ML model 300 is configured to detect presence of emergency vehicles 11 in a traffic scene 10. The early fusion ML model 300 is provided with visual data 211, audio data 212 and range data 213 which the early fusion ML model 300 determines indicates presence of an emergency vehicle 11. This means that the visual data 211, the audio data 212 and the range data 213 respectively may be labelled as indicating presence of an emergency vehicle 11. It may very well be that neither of the visual data 211, audio data 212 or range data 213 would have been labelled as indicating presence of an emergency vehicle 11 had they been processed on their own, such as by a single modality ML model, or as single modality input to the early fusion ML model 300. However, by providing this, otherwise hard to determine data, as training data for lightweight ML models 370, e.g., single modality ML models, performance of these models may be improved.

As mentioned, the early fusion ML model 300 is generally provided with a classifier 340. The classifier 340 may be a general classifier 340 configured to detect presence of specific object based on the embeddings 330 provided by the encoder 320. The general classifier 340 may be configured to detect presence of a plurality of different specific object where each specific object has a specific signature detectable by at least two of the modalities of the inputs 310 of the early fusion ML model 300. For instance, if the inputs 310 of the early fusion ML model 300 are configured to receive audio data 211 and visual data, exemplary specific object may be emergency vehicles, accidents, ice cream trucks, electric vehicles, high-performance vehicles, motorcycles, heavy-duty trucks, military vehicles, rail crossings, etc. These specific objects all have discernable auditory and visual features.

In some examples, the early fusion ML model 300, or other downstream models, are configured with more specific classifiers 341, 342, 343. In some examples, the early fusion ML model 300 is configured with a classifier 341 trained to detect presence of emergency vehicles 11 in the input data 210, in some examples, the early fusion ML model 300 is configured with a classifier 342 trained to detect presence of specific emergency vehicles 11, such as either police cars, firetrucks, etc., in the input data 210, and/or in some examples, the early fusion ML model 300 is configured with a classifier 343 trained to detect presence of accidents in the input data 210. The specific classifiers 341, 342, 343 may be trained based on ground truth data in the form of labelled data provided by the early fusion ML model configured with the general classifier 340.

In some examples, the early fusion ML model 300 may be configured with a decoder 340 as an alternative or an addition to the classifier 340. The decoder generally operates on the embeddings 330 (or latent representations) created by the encoder 320. The encoder 320 processes the input data 210, transforming it into a compressed representation that captures the essential features of e.g., the traffic scene. The decoder may interpret the abstract embeddings and generate output that directly useful. In some examples, the decoder 340 is configured to generate textual output based on the embeddings 330. The textual output may be provided as an alternative to, or in addition to, the prediction 350. Providing a decoder that generates textual output based on the embeddings 330 (e.g., the joint representation space of audio and video) may enhance interpretability, versatility, and usability across applications. A text-generating decoder 340 may be configured to interpret and describe complex scenes, events, or actions in natural language, which makes it easier for users to understand what the early fusion ML model 300 has recognized or inferred from the input data 210 e.g., the audio data 212 and visual data 211. For instance, in an AV, the early fusion ML model 300 may generate text such as “Emergency vehicle approaching from the left with sirens on”. Any descriptive text provided by the decoder 340 may be indexed or searched. Such text makes searching, identification and labelling of specific traffic scenes 10 more efficient and finding specific data for training ML models is simplified. That is to say, output from a text-generating decoder 340 may serve as a form of natural language documentation for the predictions 350 of the early fusion ML model 300, improving explainability. By translating complex, multimodal embeddings into human-readable descriptions, the decoder 340 may provide a way to audit or verify the outputs of the early fusion ML model 300. Text output may be provided to document the key aspects of what the early fusion ML model 300 “saw” and “heard,” making it possible to track decision-making in a comprehensible way. Further to this, text output generated by a decoder 340 is generally adaptable to different applications and interfaces. Text-based descriptions or summaries may be displayed on screens, converted to audio using text-to-speech systems, or embedded within user interfaces. By incorporating a text decoder 340 that has access to both e.g., audio and video features, the early fusion ML model 300 may be taught to better align these modalities (or any modalities provided at the input 310) with language. This is generally useful in training scenarios where ground-truth text descriptions are available. This multimodal-text alignment may assist the early fusion ML model 300 to improve its general understanding of concepts and context across audio, visual, and textual modalities, making it more effective at tasks like captioning, summarizing, or answering questions based on both audio and video input.

As with the labeled data, the text output may be utilized as training data for lightweight ML models 370, e.g., single modality ML models, performance of these models may be improved. For example, when developing an AV 100, operators may survey traffic scenarios involving the AV and make provide textual notes for the traffic scenario, indicating the operator's perceptions of the traffic scenario. The output may replace or complement this data and similar scenarios may be detected from e.g., driving logs and used to train e.g., onboard lightweight ML models 370 in order to improve performance of the AV 100.

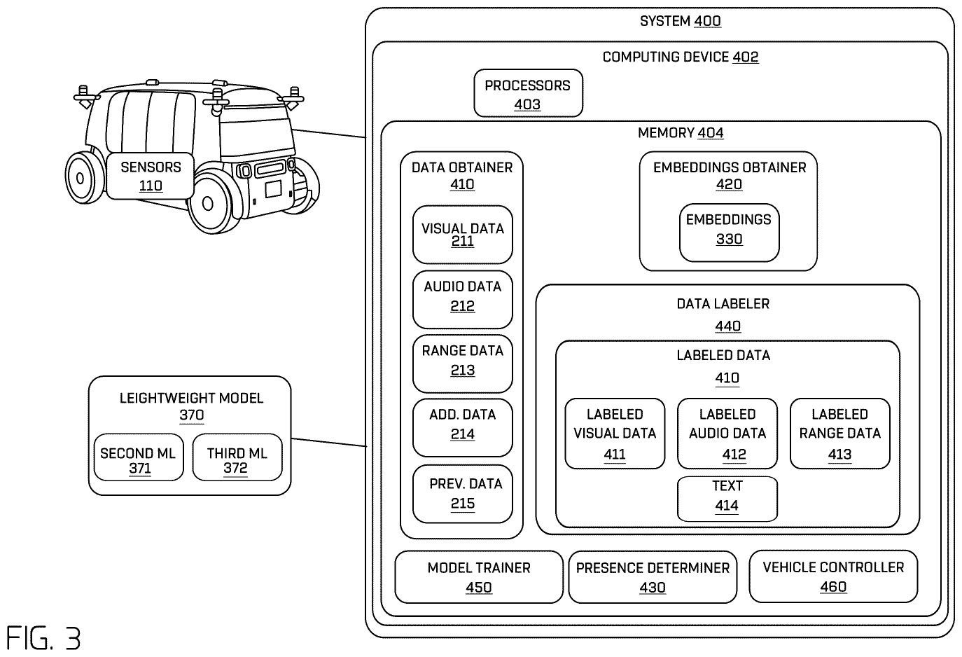

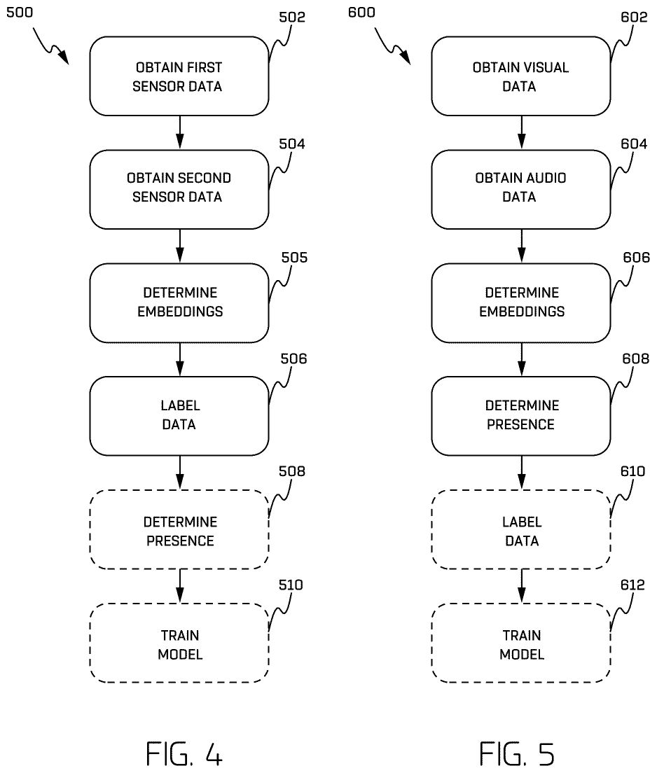

FIG. 3 depicts a block diagram of an example system 400 for implementing the techniques described herein. Although some features may be not specifically mentioned in reference to the example system 400 of FIG. 3, the system 400 of FIG. 4 may be adapted to provide any feature, functionality or effect described herein. Specifically, the system 400 of FIG. 4 may be configured to provide any feature, functionality or effect described in reference to the early fusion ML model 300.

The system 400 may be wholly or partly integrated in a vehicle 100, such as an AV 100. In some examples, the system 400 is wholly or partly stand-alone. That is to say, the system 400 may, in some examples, be remote from the vehicle 100 and operatively connected to the vehicle 100. In some examples, the system 400 may be partly integrated in the vehicle 100, and partly remote from the vehicle 100. The system 400 may be wholly or partly integrated in a server system and/or a distributed system. The dividing and allocation of the system 400 is to comprise functionality and/or services, as well as physical hardware and system components. The system 400 may be operatively connected to the vehicle 100, and/or a server system by one or more networks 200.

In the following, different features, services, functionality and devices associated with the system 400 will be described. It should be mentioned that these features, services, functionality and devices may be freely combined and that none of them are to be considered essential. Although the features, services, functionality and devices may be described as isolated blocks, this division if the features, services, functionality and devices is purely for explanatory and illustrative purposes and should be construed as limiting to the implementation of the teachings presented herein.

The system 400 comprises or is operatively connected to a computing device 402. The computing device 402 may be any suitable computing device 402 and comprise one or more processors 403. A processor 403 as used herein may be any suitable processer, processing circuitry, controller or control circuitry. The computing device 402 further comprises or is operatively connected to one or more memories 404. The memories 404 may be one or more non-transitory computer-readable media 404. Non-transitory computer readable media as used herein may be any suitable non-volatile computer readable storage such as, but not limited to, one or more and/or combinations of hard drives, solid-state drives (SSDs), optical discs such as CDs, DVDs, and Blu-ray discs, flash drives, USB drives, memory cards like SD cards and microSD cards, magnetic tapes, ROM (Read-Only Memory), EPROM (Erasable Programmable Read-Only Memory), EEPROM (Electrically Erasable Programmable Read-Only Memory), RAM (Random Access Memory) when part of a persistent storage system, network-attached storage (NAS) devices, etc. The memory 404 may comprise (store) instructions executable by the processor(s) 403. These instructions, when executed, may cause the processor(s) 403 to perform specific operations, functions and features. In the following, these operations, features and functions will be described in reference to the general system 400.

In FIG. 3, the system 400 is configured with a data obtainer 410. The data obtainer 410 is configured to obtain input data 210 for processing by the early fusion ML model 300. The data obtainer 410 is configured to obtain input data 210 of specific modalities. The data obtainer 410 may be configured to obtain input data 210 of any suitable modality. In some examples, the data obtainer 410 may be configured to obtain input data 210 of modalities provided by one or more sensors 110 of the AV 100, as previously exemplified. In some examples, the data obtainer 410 may be configured to obtain visual data 211. The visual data 211 may be provided by one or more visual sensors 111 of the AV 100. Additionally, or alternatively, the data obtainer 410 may be configured to obtain audio data 212. The audio data 212 may be provided by one or more audio sensors 112 of the AV 100. Additionally, or alternatively, the data obtainer 410 may be configured to obtain range data 213. The range data 213 may be provided by one or more range sensors 113 of the AV 100. Additionally, or alternatively, the data obtainer 410 may be configured to obtain additional data 214. The additional data 214 may be provided by one or more additional sensors of the AV 100. In some examples, the additional data 214 is of the same modality as other data obtained by the data obtainer 410, i.e., the additional data may be of a visual modality, auditory modality, range modality and/or an additional modality. Generally, the input data 210 obtained by the data obtainer 410 is comprised of mutually independent sets of data, i.e., the audio data 212 is independent from the visual data 211 as previously explained. The input data 210 obtained by the data obtainer 410 is generally related to a common event, object or environment, such as a specific traffic scene 1.

The system 400 is further configured with an embeddings determiner 420. The embeddings determiner 420 may be a transformer or encoder such as the previously presented encoder 320. The embeddings determiner 420 is configured to determine embeddings 330 for the associated input data 210 as previously explained.

The system 400 of FIG. 3 is further configured with a presence determiner 430. The presence determiner 430 is configured to determine, based on the embeddings 330, presence of one or more specific objects in the associated input data 210. The presence determiner 430 may be configured based on e.g., the previously presented classifier/decoder 340.

Additionally, or alternatively, to the presence determiner 430, the system 400 may be configured with a data labeler 440. The data labeler 440 may be configured based on e.g., the previously presented classifier/decoder 340. The data labeler 440 is configured to provide labels, classifiers, predictions, etc. associated with the input data 210. The data labeler 440 is configured to provide labeled data 410, i.e., a label determined based on classification (prediction) of the input data 210 and the input data 210. As mentioned, a classification (prediction) label together with the visual data 211 may be referred to as labeled visual data 411, the classification label together with the audio data 212 may be referred to as labeled audio data 412, and the classification label together with the range data 213 may be referred to as labeled range data, 413. Any additional data 214 may be provided with the classification label and referred to as labeled additional data.

It should be noted that the presence determiner 430 and/or the labeler may be separate ML models, such as the second ML model 371 or the third ML model 372.

In some examples, the system 400 comprises a model trainer 450. The model trainer 450 may be configured to provide labeled data 410 to additional ML models 470 for training.

In some examples, at least one of the data labeler 440 or the presence determiner 430 is configured to detect presence of emergency vehicles 11 in the input data 210. In such examples, the model trainer 450 may be configured to train, based at least in part on the labeled visual data 411, a second ML model 371 to detect emergency vehicles 11 in traffic scenes. The second ML model 371 is configured to accept at least visual data 211 as input, in some examples, the second ML model 371 is configured to operate with only visual data 211 as input. Additionally, or alternatively, in such examples, the model trainer 450 may be configured to train, based at least in part on the labeled audio data 412, a third ML model 372 to detect emergency vehicles 11 in traffic scenes. The third ML model 372 is configured to accept at least audio data 212 as input, in some examples, the third ML model 372 is configured to operate with only audio data 212 as input. In FIG. 3, the lightweight ML models 370, the second ML model 371 and the third ML model 372 are shown as operatively connected to the system 400. However, in some examples, the second ML model 371 and/or the third ML 372 may very well be completely independent from the system 400 comprised in the system 400 or only be associated with the system 400 by the labeled data 410 provided by the system 400.

The data labeler 440 may, in some examples be configured to provide textual output 414 as e.g., exemplified with reference to the text-generating decoder 340.

In some examples, the data obtainer 410 may be configured to obtain previously labeled data 215. The previously labeled data 215 may be sensor data 211, 212, 213 labeled by one or more lightweight models 370. For instance, the preciously may comprise visual data 211 labeled by e.g., the second ML model 371, and/or audio data 212 labeled by e.g., the third ML model 372. This previously labeled data 215 may be provided to the embeddings obtainer 420 to provide a set of embeddings 330 from which the data labeler 440 could provide labeled data 411, 412, 413, relabeled sensor data (not explicitly indicated in FIG. 3). The relabeled data may be compared to the previously labeled data 215 and any discrepancies may indicate a particularly difficult traffic scenario where a lightweight model 370 fails to e.g., accurately determine presence of a specific object, i.e. outputting false positives or false negatives. The relabeled data may then be used for training, by the model trainer 450, the lightweight model 370 in order to further improve performance of the lightweight model 370, i.e., the second ML model 371 and/or the third ML model 372 in order to reduce a risk of false positive or false negative detections of e.g., emergency vehicles 11 in a traffic scene 10. In other embodiments, the previously labeled data 215, for which discrepancies have been indicated, may be filtered out from the training of the lightweight model 370 or updated with regards to its labeling to reflect the output indicated by the data labeler 440, or presence determiner (if applicable).

Additionally, or alternatively, the model trainer 450 may be configured to train the embeddings determiner 420, the presence determiner 430, and/or the data labeler 440. In other words, the model trainer 450 may be configured to train the early fusion ML model 300. Assuming the early fusion ML model 300 is to be trained to detect emergency vehicles 11 in a traffic scene 10. The model trainer 450 may be configured to obtain a dataset comprising synchronized audio and video clips with labeled instances of emergency vehicles, such as ambulances or police cars, as well as non-emergency vehicles or background scenes. Each instance in the dataset may include audio features, like siren sounds, and video features, like flashing lights or specific vehicle shapes, which are indicative of emergency vehicles.

In some examples, the model trainer 450 may be configured to train or configure the embeddings determiner 420, the encoder 320 e.g., a transformer, of the early fusion ML model 300. Such training involves training the embeddings determiner 420 to, efficiently, process each input modality and extract relevant features for the task at hand (e.g., identifying specific objects). In one example, where the goal is to detect emergency vehicles 11 based on both audio data 212 and video data 211, the encoder 320 is generally configured and trained to capture meaningful representations from each modality, visual patterns in the video data 211 and auditory cues in the audio data 212. In some examples, training the encoder 320 comprises determining a separate encoder architecture for each modality that is well-suited to the type of data it will process. For the visual data 211, a CNN may be chosen, as CNNs are generally considered effective at extracting spatial features from images and video frames. In some examples, the CNN encoder is pre-trained on a large, general-purpose dataset (such as ImageNet) to give it a foundation for understanding visual structures. Such pre-training allows the encoder to start with learned filters for basic shapes, textures, and colors, which can later be fine-tuned for the specific task of identifying emergency vehicles 11. During fine-tuning, the model will generally adjust its parameters based on labeled video data showing examples of emergency vehicles 11, thereby learning to recognize features like flashing lights or specific vehicle outlines. Correspondingly, for the audio data 212, an encoder based on RNNs, LSTM or transformers may be determined. Such encoders are generally considered suitable architectures when it comes to capturing temporal patterns in sequential data. Similar to the video encoder, the audio encoder may be pre-trained on a dataset of general audio data or environmental sounds to learn basic temporal features like rhythms or pitch changes. This pre-trained encoder may then be fine-tuned using specific emergency vehicle audio data, where it learns to detect the unique patterns of sirens or other relevant sounds. During training, the encoders for each modality may be configured to generate embeddings in a shared latent space where the features from audio and video may be combined and aligned. To achieve this, both encoders may be trained jointly in an end-to-end manner, where the error or loss from the classifier's predictions backpropagates through both the audio and video encoders. This joint training allows each encoder to adjust its parameters in a way that makes the resulting embeddings 330 compatible and meaningful in the shared space. For example, the audio encoder will learn to generate embeddings that are aligned with relevant visual features (like flashing lights and sirens), while the video encoder aligns with audio cues (like sounds of vehicle engines and sirens).

Alternatively, the trainer 450 may be configured to train the encoder 320 using contrastive learning or cross-modal alignment techniques. In such examples, the encoder is trained to pull together embeddings of audio and video data that correspond to the same event (e.g., an emergency vehicle 11) and push apart embeddings that correspond to different events. This alignment helps the encoders learn features that are not only distinctive within each modality but also complementary when combined.

Additionally, the trainer 450 may configured to apply regularization techniques such as dropout or batch normalization to prevent overfitting. This may be particularly efficient for the early fusion ML model 300 since multimodal data may lead to high-dimensional embeddings. Additionally, hyperparameter tuning may be provided by the trainer 450 to balance encoder configurations, such as choosing the right embedding size, learning rate, and layer depth for each encoder.

In some examples, the model trainer 450 may be configured to train or configure the presence determiner 430 or the data labeler 440, i.e., the classifier 340. In some examples, the model trainer 450 is configured to train the classifier 340 by connecting the encoder 320 and the classifier 340 end-to-end so that the embeddings 330 produced by the encoder 320 are fed into the classifier 330. The classifier 340 is trained using labeled data, where each training instance comprises embeddings 330 of the joint representation space and a corresponding label (e.g., “emergency vehicle” or “non-emergency vehicle”). A loss function, e.g., categorical cross-entropy, may be applied to measure a difference between a prediction 350 of the classifier 340 and the actual label, generating a loss value that indicates a performance of the classifier 340 on that instance. Through backpropagation, this loss may be used to adjust parameters in the classifier 330 and, optionally depending on the setup, potentially the encoder 330. With each training iteration, parameters of the classifier 340 are updated to reduce a classification error, allowing the classifier 340 to learn from patterns in the fused embeddings 330. The early fusion (joint representation space) helps the classifier 340 develop a nuanced understanding of cross-modal relationships. For instance, the classifier may be taught that the sound of a siren combined with flashing lights strongly indicates an emergency vehicle, while either feature alone may not be as definitive.

The system 400 may further comprise a vehicle controller 460. The vehicle controller 460 is configured to cause control of a vehicle, e.g., the AV 100, based on data from the presence determiner and/or the data labeler 440. Additionally, or alternatively, in some examples, the vehicle controller 460 is configured to cause control of a vehicle 100 based on data from the second ML model 371 and/or the third ML model 372. The vehicle controller 460 may be configured to cause the vehicle 100 to e.g., determine location and/or velocity of a detected emergency vehicle 11. If, for instance, the emergency vehicle 11 is approaching from behind or in the same lane, the AV 100 may be caused to yield by e.g., safely pulling over to a side of the road.

It should be mentioned that, albeit the early fusion ML model 300 is described as operating with input data 210 of two or more modalities, the early fusion ML model 300 may very well be configured to accept also single modality input data 210. This may be useful if, e.g., one sensor 111, 112, 113 malfunctions or is unavailable. Furthermore, the early fusion ML model 300 may be configured to accept more than one input data 210 of a specific modality from mutually independent sensors 111, 112, 113. In other words, the early fusion ML model 300 may receive two or more sets of visual data 211 provided by mutually independent visual sensors 111, two or more sets of audio data 212 provided by mutually independent audio sensors 112, and/or two or more sets of range data 213 provided by mutually independent visual sensors 113. In some examples, the early fusion ML model 300 may be configured to accept more than one input data 210 of a first modality from first sensors 111, 112, 113 that are not mutually independent, in such examples, further input data 210 from second sensors 111, 112, 113 providing sensor data 211, 212, 213 of a second modality and being independent from the first sensors 111, 112, 113 would generally be provided.

In some examples, training of the early fusion ML model 300 may not require training data comprising sensor data 211, 212, 213 of different modalities provided by mutually independent sensors 111, 112, 113. The early fusion ML model 300 may, to a part, be trained based on training data of a single modality, such as visual data 211, audio data 212, or range data 213.

FIG. 4 depicts an example process 500 in accordance with examples of the disclosure. The process 500 may be performed stand-alone. In some examples, the process 500 is described by instructions executable by one or more processors, such as the processors 403 introduced with reference to FIG. 3. The instructions may be stored on one or more non-transitory computer-readable media such as the memory 404 introduced in reference to FIG. 3. The process 500 presented with reference to FIG. 4 may very well comprise any feature, example or effect presented herein. The process 500 may specifically comprise any details presented in reference to the system 400 of FIG. 3, and the system 400 of FIG. 3 may very well be configured to provide any, or all of the features of the process 500 of FIG. 4.

The process 500 comprises obtaining 502, first sensor data 211, 212, 213 acquired by a first sensor 111, 112, 113 and associated with a traffic scene 10. The obtaining 502 may be provided as presented herein according to any example, feature or function, such as by the data obtainer 410 introduced with reference to FIG. 3. In some examples, the first sensor is one of an optical sensor 111 (configured to provide visual data 211) or a range sensor 113 such as a radar sensor 113 (configured to provide range data 213).

The process 500 further comprises obtaining 504, second sensor data 211, 212, 213 acquired by a second sensor 111, 112, 113 and associated with the traffic scene 10. The first sensor 111, 112, 113 and the second sensor 111, 112, 113 are mutually independent and of different modalities. The obtaining 504 may be provided as presented herein according to any example, feature or function, such as by the data obtainer 410 introduced with reference to FIG. 3. In some examples, the second sensor is an audio sensor 112.

The process 500 further comprises determining 505, by an encoder 320 and based at least in part on the first sensor data 211, 212, 213 and the second sensor data 211, 212, 213, embeddings 330 for the traffic scene 10. The embeddings 330 represent a joint representation space for the different modalities. The determining 505 may be provided as presented herein according to any example, feature or function, such as by the embeddings determiner 420 introduced with reference to FIG. 3, the encoder 320 of FIG. 1, the encoder 320 of FIG. 2 or combinations thereof.

The process 500 further comprises labeling 506, based at least in part on the embeddings 330, at least one of the first sensor data 211, 212, 213 or the second sensor data 211, 212, 213 thereby providing labeled sensor data. The labeling 506 may be provided as presented herein according to any example, feature or function, such as by the data labeler 440 introduced with reference to FIG. 3.

Optionally, in some examples, process 500 further comprises determining 508, by a first machine learning model 300, and based at least in part on the embeddings 330, presence of an object of a specific type in the traffic scene. The determining 508 may be provided as presented herein according to any example, feature or function, such as by the presence determiner 430 or the data labeler 440 introduced with reference to FIG. 3, the classifier 340 of FIG. 1, the classifiers 341, 342, 343 of FIG. 2 or combinations thereof. In some examples, the first machine learning model 300 is configured to detect presence of one or more emergency vehicles, accidents, ice cream trucks, electric vehicles, high-performance vehicles, motorcycles, heavy-duty trucks, military vehicles or rail crossings.

In some examples, labeling 506 the at least one of the first sensor data or the second sensor data, as previously presented, may be based at least in part on determining 508 presence of the object of the specific type.

Optionally, in some examples, process 500 further comprises training 510, based at least in part on ground truth data of different modalities associated with the same traffic scene, the first machine learning model 300; and training 510, based at least in part on ground truth data of a single modality associated with a traffic scene, the first machine learning model 300. The training 510 may be provided as presented herein according to any example, feature or function, such as by the model trainer 450 introduced with reference to FIG. 3.

Optionally, in some examples, process 500 further comprises training 510, based at least in part on the labeled sensor data 410, a second machine learning model 342, 343 configured to detect objects of a specific type in traffic scenes. An accepted modality of the second machine learning model 342, 343 is at least a modality of the labeled sensor data 410, and the objects of the specific type are emergency vehicles 11. The training 510 may be provided as presented herein according to any example, feature or function, such as by the model trainer 450 introduced with reference to FIG. 3.

Optionally, in some examples, process 500 further comprises controlling (not shown in FIG. 4), based at least in part on determining 508 presence of objects of the specific type in the traffic scene 10, operation of an autonomous vehicle 100. The controlling may be provided as presented herein according to any example, feature or function, such as by the vehicle controller 460 introduced with reference to FIG. 3.

Optionally, in some examples, the process 500 may further comprise obtaining (not shown in FIG. 4) previously labeled sensor data 215. The previously labeled data 215 comprises audio data and/or visual data 211, 212 labeled by a second or third machine learning model 371, 372. The obtaining may be provided as presented herein according to any example, feature or function, such as by the data obtainer 410 introduced with reference to FIG. 3. Such example may further comprise labeling 506, based at least in part on the embeddings, the previously labeled data, thereby providing relabeled sensor data. The labeling 506 may, as mentioned, be provided as presented herein according to any example, feature or function, such as by the data labeler 440 introduced with reference to FIG. 3. Such examples may further comprise comparing (not indicated in FIG. 4) labels of the previously labeled data to labels of the relabeled sensor data. The comparing may be provided by any suitable example, feature or function, such as the system 400 of FIG. 3. Examples may further comprise training 510, based at least in part on the comparison, one or more of the second or third machine learning models. Also this training 510 may be provided as presented herein according to any example, feature or function, such as by the model trainer 450 introduced with reference to FIG. 3.

FIG. 5 depicts an example process 600 in accordance with examples of the disclosure. The process 600 may be performed stand-alone. In some examples, the process 600 is described by instructions executable by one or more processors, such as the processors 403 introduced with reference to FIG. 3. The instructions may be stored on one or more non-transitory computer-readable media such as the memory 404 introduced in reference to FIG. 3. The process 600 presented with reference to FIG. 4 may very well comprise any feature, example or effect presented herein. The process 600 may specifically comprise any details presented in reference to the system 400 of FIG. 3 and/or the process 500 of FIG. 4, and the system 400 FIG. 3 and/or process 500 of FIG. 4 may very well be configured to provide any, or all of the features of the process 600 of FIG. 5.

The process 600 comprises obtaining 602, visual data 211 acquired by a first image sensor 111 and associated with a traffic scene 10. The obtaining 602 may be provided as presented herein according to any example, feature or function, such as by the data obtainer 410 introduced with reference to FIG. 3.

The process 600 further comprises obtaining 604, audio data acquired by a first audio sensor 1112 and associated with the traffic scene 10. The first audio sensor 112 and the first optical sensor 111 are mutually independent. The obtaining 604 may be provided as presented herein according to any example, feature or function, such as by the data obtainer 410 introduced with reference to FIG. 3.

The process 600 further comprises determining 606, based at least in part on the visual data 211 and the audio data 212, embeddings 330 for the traffic scene 10 that represent a joint representation space for the different modalities. The determining 606 may be provided as presented herein according to any example, feature or function, such as by the embeddings determiner 420 introduced with reference to FIG. 3, the encoder 320 of FIG. 1, the encoder 320 of FIG. 2 or combinations thereof.

The process 600 further comprises determining 608, by a first machine learning model 300, and based at least in part on the embeddings 330, presence of an emergency vehicle 11 in the traffic scene 10. The determining 608 may be provided as presented herein according to any example, feature or function, such as by the presence determiner 430 or the data labeler 440 introduced with reference to FIG. 3, the classifier 340 of FIG. 1, the classifiers 341, 342, 343 of FIG. 2 or combinations thereof.

In some examples, the process 600 may further comprise labeling 610, based at least in part on at least one of the embeddings 330 or determining 608 presence of an emergency vehicle 11, the visual data 211 thereby providing labeled visual data 411. Additionally, or alternatively, the process 600 may comprise labeling 610, based at least in part on at least one of the embeddings 330 or determining 608 presence of an emergency vehicle 11, the audio data 212 thereby providing labeled audio data 412. The labeling 610 may be provided as presented herein according to any example, feature or function, such as by the data labeler 440 introduced with reference to FIG. 3.

In some examples, the process 600 may further comprise training 612, based at least in part on the labeled visual data 411, a second machine learning model 342 configured to accept at least visual data 211 as input to detect emergency vehicles 11 in traffic scenes. Additionally, or alternatively, the process 600 may further comprise training 612, based at least in part on the labeled audio data 412, a third machine learning model 343 configured to accept at least audio data 212 as input to detect emergency vehicles 11 in traffic scenes. The training 612 may be provided as presented herein according to any example, feature or function, such as by the model trainer 450 introduced with reference to FIG. 3.

In some examples, the process 600 may further comprise obtaining (not shown in FIG. 5), range data 213 acquired by a first range sensor 113 and associated with the traffic scene 10, wherein the range sensor 113 is a radar sensor or a lidar sensor. The obtaining may be provided as presented herein according to any example, feature or function, such as by the data obtainer 410 introduced with reference to FIG. 3. Such examples may further comprise determining 606, based at least in part on the range data 113, the embeddings 330.

Optionally, in some examples, process 500 further comprises controlling (not shown in FIG. 5), based at least in part on determining 608 presence of objects of the specific type in the traffic scene 10, operation of an autonomous vehicle 100. The controlling may be provided as presented herein according to any example, feature or function, such as by the vehicle controller 460 introduced with reference to FIG. 3.

### Additional Example Vehicle System

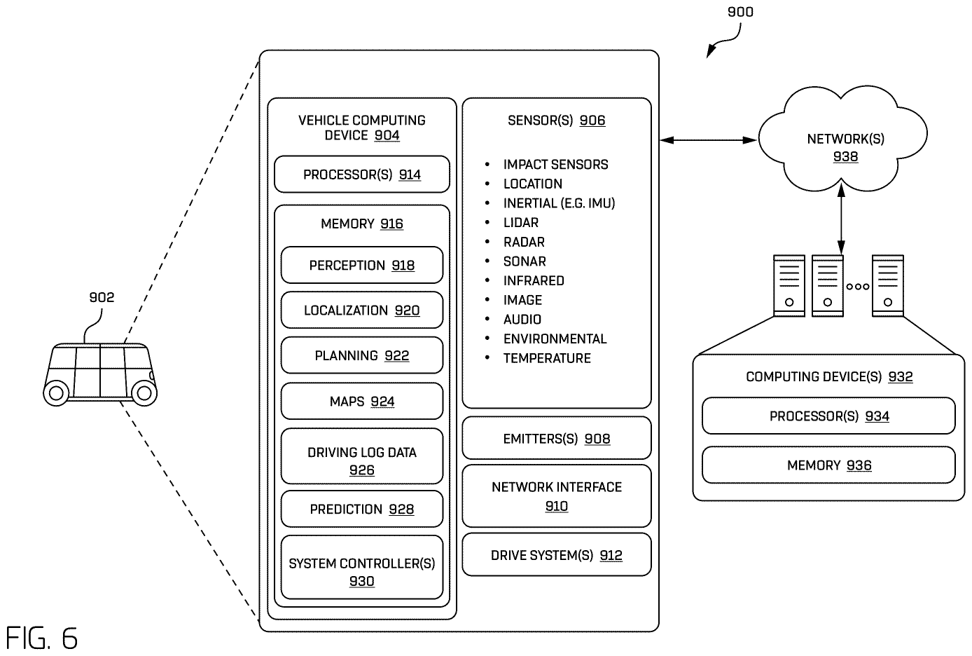

FIG. 6 illustrates a block diagram of an example system 900 that implements the techniques discussed herein. FIG. 6 may represent the example implementation of FIG. 3. In some instances, the example system 900 may include a vehicle 902, which may represent the vehicle 100 in FIGS. 1-3. In some instances, the vehicle 902 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the vehicle 902 may be a fully or partially autonomous vehicle having any other level or classification. Moreover, in some instances, the techniques described herein may be usable by non-autonomous vehicles as well.

The vehicle 902 may include a vehicle computing device(s) 904 (representing computing device(s) 402 in FIG. 3), sensor(s) 906 (representing sensors 111, 112, 113 in FIG. 2 and sensors 210 in FIG. 3), emitter(s) 908, network interface(s) 910, and/or drive system(s) 912. The system 900 may additionally or alternatively comprise computing device(s) 932.

In some instances, the sensor(s) 906 may include lidar sensors, radar sensors, ultrasonic transducers, sonar sensors, location sensors (e.g., global positioning system (GPS), compass, etc.), inertial sensors (e.g., inertial measurement units (IMUs), accelerometers, magnetometers, gyroscopes, etc.), image sensors (e.g., red-green-blue (RGB), infrared (IR), intensity, depth, time of flight cameras, etc.), audio sensors (microphones), wheel encoders, environment sensors (e.g., thermometer, hygrometer, light sensors, pressure sensors, etc.), etc. The sensor(s) 906 may include multiple instances of each of these or other types of sensors. For instance, the radar sensors may include individual radar sensors located at the corners, front, back, sides, and/or top of the vehicle 902. As another example, the cameras may include multiple cameras disposed at various locations about the exterior and/or interior of the vehicle 902. The sensor(s) 906 may provide input to the vehicle computing device(s) 904 and/or to computing device(s) 932. The sensor(s) 906 may be operable to detect a state of the vehicle 902.

The vehicle 902 may also include emitter(s) 908 for emitting light and/or sound, as described above. The emitter(s) 908 may include interior audio and visual emitter(s) to communicate with passengers of the vehicle 902. Interior emitter(s) may include speakers, lights, signs, display screens, touch screens, haptic emitter(s) (e.g., vibration and/or force feedback), mechanical actuators (e.g., seatbelt tensioners, seat positioners, headrest positioners, etc.), and the like. The emitter(s) 908 may also include exterior emitter(s). Exterior emitter(s) may include lights to signal a direction of travel or other indicator of vehicle action (e.g., indicator lights, signs, light arrays, etc.), and one or more audio emitter(s) (e.g., speakers, speaker arrays, horns, etc.) to audibly communicate with pedestrians or other nearby vehicles, one or more of which comprising acoustic beam steering technology.

The vehicle 902 may also include network interface(s) 910 that enable communication between the vehicle 902 and one or more other local or remote computing device(s). The network interface(s) 910 may facilitate communication with other local computing device(s) on the vehicle 902 and/or the drive component(s) 912. The network interface(s) 910 may additionally or alternatively allow the vehicle to communicate with other nearby computing device(s) (e.g., other nearby vehicles, traffic signals, etc.). The network interface(s) 910 may additionally or alternatively enable the vehicle 902 to communicate with computing device(s) 932 over a network 938. In some examples, computing device(s) 932 may comprise one or more nodes of a distributed computing system (e.g., a cloud computing architecture).

The vehicle 902 may include one or more drive components 912. In some instances, the vehicle 902 may have a single drive component 912. In some instances, the drive component(s) 912 may include one or more sensors to detect conditions of the drive component(s) 912 and/or the surroundings of the vehicle 902. By way of example and not limitation, the sensor(s) of the drive component(s) 912 may include one or more wheel encoders (e.g., rotary encoders) to sense rotation of the wheels of the drive components, inertial sensors (e.g., inertial measurement units, accelerometers, gyroscopes, magnetometers, etc.) to measure orientation and acceleration of the drive component, cameras or other image sensors, ultrasonic sensors to acoustically detect objects in the surroundings of the drive component, lidar sensors, radar sensors, etc. Some sensors, such as the wheel encoders may be unique to the drive component(s) 912. In some cases, the sensor(s) on the drive component(s) 912 may overlap or supplement corresponding systems of the vehicle 902 (e.g., sensor(s) 906).

The drive component(s) 912 may include many of the vehicle systems, including a high voltage battery, a motor to propel the vehicle, an inverter to convert direct current from the battery into alternating current for use by other vehicle systems, a steering system including a steering motor and steering rack (which may be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive component(s) 912 may include a drive component controller which may receive and pre-process data from the sensor(s) and to control operation of the various vehicle systems. In some instances, the drive component controller may include one or more processors and memory communicatively coupled with the one or more processors. The memory may store one or more components to perform various functionalities of the drive component(s) 912. Furthermore, the drive component(s) 912 may also include one or more communication connection(s) that enable communication by the respective drive component with one or more other local or remote computing device(s).

The vehicle computing device(s) 904 may include processor(s) 914 (representing processor(s) 130 in FIG. 3) and memory 916 (representing memory 140 in FIG. 4) communicatively coupled with the one or more processors 914. Computing device(s) 932 may also include processor(s) 934, and/or memory 936. The processor(s) 914 and/or 934 may be any suitable processor capable of executing instructions to process data and perform operations as described herein. By way of example and not limitation, the processor(s) 914 and/or 934 may comprise one or more central processing units (CPUs), graphics processing units (GPUs), integrated circuits (e.g., application-specific integrated circuits (ASICs)), gate arrays (e.g., field-programmable gate arrays (FPGAs)), and/or any other device or portion of a device that processes electronic data to transform that electronic data into other electronic data that may be stored in registers and/or memory.

Memory 916 (representing memory 140 in FIGS. 3) and/or 936 may be examples of non-transitory computer-readable media. The memory 916 and/or 936 may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), non-volatile/Flash-type memory, or any other type of memory capable of storing information. The architectures, systems, and individual elements described herein may include many other logical, programmatic, and physical components, of which those shown in the accompanying figures are merely examples that are related to the discussion herein.

In some instances, the memory 916 and/or memory 936 may store a perception component 918, localization component 920, planning component 922, map(s) 924, driving log data 926, prediction component 928, and/or system controller(s) 930—zero or more portions of any of which may be hardware, such as GPU(s), CPU(s), and/or other processing units.

The perception component 918 may detect object(s) in in an environment surrounding the vehicle 902 (e.g., identify that an object exists), classify the object(s) (e.g., determine an object type associated with a detected object), segment sensor data and/or other representations of the environment (e.g., identify a portion of the sensor data and/or representation of the environment as being associated with a detected object and/or an object type), determine characteristics associated with an object (e.g., a track identifying current, predicted, and/or previous position, heading, velocity, and/or acceleration associated with an object), and/or the like. Data determined by the perception component 918 is referred to as perception data. The perception component 918 may be configured to associate a bounding region (or other indication) with an identified object. The perception component 918 may be configured to associate a confidence score associated with a classification of the identified object with an identified object. In some examples, objects, when rendered via a display, can be colored based on their perceived class. The object classifications determined by the perception component 918 may distinguish between different object types such as, for example, a passenger vehicle, a pedestrian, a bicyclist, motorist, a delivery truck, a semi-truck, traffic signage, and/or the like. The perception component 918 may be operable to detect a state of the vehicle 902.

In at least one example, the localization component 920 may include hardware and/or software to receive data from the sensor(s) 906 to determine a position, velocity, and/or orientation of the vehicle 902 (e.g., one or more of an x-, y-, z-position, roll, pitch, or yaw). For example, the localization component 920 may include and/or request/receive map(s) 924 of an environment and can continuously determine a location, velocity, and/or orientation of the autonomous vehicle 902 within the map(s) 924. In some instances, the localization component 920 may utilize SLAM (simultaneous localization and mapping), CLAMS (calibration, localization and mapping, simultaneously), relative SLAM, bundle adjustment, non-linear least squares optimization, and/or the like to receive image data, lidar data, radar data, IMU data, GPS data, wheel encoder data, and the like to accurately determine a location, pose, and/or velocity of the autonomous vehicle. In some instances, the localization component 920 may provide data to various components of the vehicle 902 to determine an initial position of an autonomous vehicle for generating a trajectory and/or for generating map data, as discussed herein. In some examples, localization component 920 may provide, to the perception component 918, a location and/or orientation of the vehicle 902 relative to the environment and/or sensor data associated therewith. The localization component 920 may be operable to detect a state of the vehicle 902.

The planning component 922 may receive a location and/or orientation of the vehicle 902 from the localization component 920 and/or perception data from the perception component 918 and may determine instructions for controlling operation of the vehicle 902 based at least in part on any of this data. In some examples, determining the instructions may comprise determining the instructions based at least in part on a format associated with a system with which the instructions are associated (e.g., first instructions for controlling motion of the autonomous vehicle may be formatted in a first format of messages and/or signals (e.g., analog, digital, pneumatic, kinematic) that the system controller(s) 930 and/or drive component(s) 912 may parse/cause to be carried out, second instructions for the emitter(s) 908 may be formatted according to a second format associated therewith).

The driving log data 926 may comprise sensor data, perception data, and/or scenario labels collected/determined by the vehicle 902 (e.g., by the perception component 918), as well as any other message generated and or sent by the vehicle 902 during operation including, but not limited to, control messages, error messages, etc. In some examples, the vehicle 902 may transmit the driving log data 926 to the computing device(s) 932.

The prediction component 928 may generate one or more probability maps representing prediction probabilities of possible locations of one or more objects in an environment. For example, the prediction component 928 may generate one or more probability maps for vehicles, pedestrians, animals, and the like within a threshold distance from the vehicle 902. In some examples, the prediction component 928 may measure a track of an object and generate a discretized prediction probability map, a heat map, a probability distribution, a discretized probability distribution, and/or a trajectory for the object based on observed and predicted behavior. In some examples, the one or more probability maps may represent an intent of the one or more objects in the environment. In some examples, the planner component 922 may be communicatively coupled to the prediction component 928 to generate predicted trajectories of objects in an environment. For example, the prediction component 928 may generate one or more predicted trajectories for objects within a threshold distance from the vehicle 902. In some examples, the prediction component 928 may measure a trace of an object and generate a trajectory for the object based on observed and predicted behavior. Although prediction component 928 is shown on a vehicle 902 in this example, the prediction component 928 may also be provided elsewhere, such as in a remote computing device. In some examples, a prediction component may be provided at both a vehicle and a remote computing device. These components may be configured to operate according to the same or a similar algorithm.

The memory 916 and/or 936 may additionally or alternatively store a mapping system, a planning system, a ride management system, etc. Although perception component 918 and/or planning component 922 are illustrated as being stored in memory 916, perception component 918 and/or planning component 922 may include processor-executable instructions, machine-learned model(s) (e.g., a neural network), and/or hardware.

As described herein, the localization component 920, the perception component 918, the planning component 922, and/or other components of the system 900 may comprise one or more ML models. For example, the localization component 920, the perception component 918, and/or the planning component 922 may each comprise different ML model pipelines. In some examples, an ML model may comprise a neural network. An exemplary neural network is a biologically inspired algorithm which passes input data through a series of connected layers to produce an output. Each layer in a neural network can also comprise another neural network or can comprise any number of layers (whether convolutional or not). As can be understood in the context of this disclosure, a neural network can utilize machine-learning, which can refer to a broad class of such algorithms in which an output is generated based on learned parameters.

Although discussed in the context of neural networks, any type of machine-learning can be used consistent with this disclosure. For example, machine-learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3(ID3 ), Chi-squared automatic interaction detection (CHAD)), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet-50, ResNet-101, VGG, DenseNet, PointNet, and the like. In some examples, the ML model discussed herein may comprise PointPillars, SECOND, top-down feature layers (e.g., see U.S. patent application Ser. No. 15/963,833, which is incorporated in its entirety herein), and/or VoxelNet. Architecture latency optimizations may include MobilenetV2, Shufflenet, Channelnet, Peleenet, and/or the like. The ML model may comprise a residual block such as Pixor, in some examples.

Memory 920 may additionally or alternatively store one or more system controller(s) 930 which may be configured to control steering, propulsion, braking, safety, emitters, communication, and other systems of the vehicle 902. These system controller(s) 930 may communicate with and/or control corresponding systems of the drive component(s) 912 and/or other components of the vehicle 902.

It should be noted that while FIG. 7 is illustrated as a distributed system, in alternative examples, components of the vehicle 902 may be associated with the computing device(s) 932 and/or components of the computing device(s) 932 may be associated with the vehicle 902. That is, the vehicle 902 may perform one or more of the functions associated with the computing device(s) 932, and vice versa.

### EXAMPLE CLAUSES

A: A system comprising one or more processors; and one or more non-transitory computer-readable media storing instructions executable by the one or more processors, wherein the instructions, when executed, cause the system to perform operations comprising: obtaining, visual data acquired by a first image sensor and associated with a traffic scene; obtaining, audio data acquired by a first audio sensor and associated with the traffic scene, wherein the first audio sensor and the first image sensor are mutually independent; determining, based at least in part on the visual data and the audio data, embeddings for the traffic scene that represent a joint representation space for the different modalities; and determining, by a first machine learning model, and based at least in part on the embeddings, presence of an emergency vehicle in the traffic scene.
B: The system of clause A, wherein the instructions, when executed, cause the system to perform operations further comprising: obtaining, range data acquired by a first range sensor and associated with the traffic scene, wherein the range sensor is a radar sensor or a lidar sensor; and
   determining, based at least in part on the range data, the embeddings.
C: The system of clause A or B, wherein the instructions, when executed, cause the system to perform operations further comprising: labeling, based at least in part on at least one of the embeddings or determining presence of an emergency vehicle, the visual data thereby providing labeled visual data; and training, based at least in part on the labeled visual data, a second machine learning model configured to accept at least visual data as input to detect emergency vehicles in traffic scenes.
D: The system of any one of clause A to C, wherein the instructions, when executed, cause the system to perform operations further comprising: labeling, based at least in part on at least one of the embeddings or determining presence of an emergency vehicle, the audio data thereby providing labeled audio data; and training, based at least in part on the labeled audio data, a third machine learning model configured to accept at least audio data as input to detect emergency vehicles in traffic scenes.
E: The system of any one of clause A to D, wherein the instructions, when executed, cause the system to perform operations further comprising: controlling, based at least in part on determining presence of an emergency vehicle in the traffic scene, operation of an autonomous vehicle.
F: A method comprising: obtaining, first sensor data acquired by a first sensor and associated with a traffic scene; obtaining, second sensor data acquired by a second sensor and associated with the traffic scene, wherein the first sensor and the second sensor are mutually independent and of different modalities; determining, based at least in part on the first sensor data and the second sensor data, embeddings for the traffic scene that represent a joint representation space for the different modalities; and labeling, based at least in part on the embeddings, at least one of the first sensor data or the second sensor data thereby providing labeled sensor data.
G: The method of clause F, further comprising: training, based at least in part on the labeled sensor data, a second machine learning model configured to detect objects of a specific type in traffic scenes, wherein an accepted modality of the second machine learning model is at least a modality of the labeled sensor data, and the objects of the specific type are emergency vehicles.
H: The method of clause F or G, wherein the second sensor is an audio sensor.
I: The method of any one of clause F to G, wherein the first sensor is one of an optical sensor or a radar sensor.
J: The method of any one of clause F to I, wherein the first sensor is an image sensor, the second sensor is an audio sensor and the method further comprises: obtaining, range data acquired by a third sensor and associated with the traffic scene, wherein the third sensor is a radar sensor or lidar sensor; and determining, and based at least in part on the range data, the embeddings.
K: The method of any one of clause F to J, further comprising: obtaining, additional data acquired by an additional sensor and associated with the traffic scene, wherein the additional data is of the same modality as one of the first sensor data or the second sensor data and wherein the additional sensor is independent from the first sensor and the second sensor; and determining, based at least in part on the additional data, the embeddings.
L: The method of any one of clause F to K, further comprising: obtaining previously labeled sensor data, wherein the previously labeled data is audio data and/or visual data labeled by a second or third machine learning model; labeling, based at least in part on the embeddings, the previously labeled data, thereby providing relabeled sensor data; comparing labels of the previously labeled data to labels of the relabeled sensor data; and training, based at least in part on the comparison, one or more of the second or third machine learning models.
M: The method of any one of clause F to L, further comprising: determining, by a first machine learning model, and based at least in part on the embeddings, presence of an object of a specific type in the traffic scene.
N: The method of clause M wherein the first machine learning model is configured to detect presence of one or more emergency vehicles, accidents, ice cream trucks, electric vehicles, high-performance vehicles, motorcycles, heavy-duty trucks, military vehicles or rail crossings.
O: The method of clause M or N, further comprising: labeling, based at least in part on determining presence of the object of the specific type, the at least one of the first sensor data or the second sensor data.
P: The method of any one of clause M to O, further comprising: training, based at least in part on ground truth data of different modalities associated with the same traffic scene, the first machine learning model; and training, based at least in part on ground truth data of a single modality associated with a traffic scene, the first machine learning model.
Q: The method of any one of clause M to P, further comprising: controlling, based at least in part on determining presence of objects of the specific type in the traffic scene, operation of an autonomous vehicle.
R: One or more non-transitory computer-readable media storing instructions executable by one or more processors, wherein the instructions, when executed, cause the one or more processors to perform operations comprising: obtaining, first sensor data acquired by a first sensor and associated with a traffic scene; obtaining, second sensor data acquired by a second sensor and associated with the traffic scene, wherein the first sensor and the second sensor are mutually independent and of different modalities; determining, based at least in part on the first sensor data and the second sensor data, embeddings for the traffic scene that represent a joint representation space for the different modalities; and labeling, based at least in part on the embeddings, at least one of the first sensor data or the second sensor data thereby providing labeled sensor data.
S: The non-transitory computer-readable media of clause R, wherein the instructions, when executed, cause the one or more processors to perform operations further comprising: training, based at least in part on the labeled sensor data, a second machine learning model configured to detect objects of a specific type in traffic scenes, wherein an accepted modality of the second machine learning model is at least a modality of the labeled sensor data, and the objects of the specific type are emergency vehicles.
T: The non-transitory computer-readable media of clause R or S, wherein the instructions, when executed, cause the one or more processors to perform operations further comprising: determining, by a first machine learning model, and based at least in part on the embeddings, presence of an object of a specific type in the traffic scene.

While the example clauses described above are described with respect to one particular implementation, it should be understood that, in the context of this document, the content of the example clauses can also be implemented via a method, device, system, computer-readable medium, and/or another implementation. Additionally, any of examples A-## may be implemented alone or in combination with any other one or more of the examples A-##.

### Conclusion

While one or more examples of the techniques described herein have been described, various alterations, additions, permutations, and equivalents thereof are included within the scope of the techniques described herein.

In the description of examples, reference is made to the accompanying drawings that form a part hereof, which show by way of illustration specific examples of the claimed subject matter. It is to be understood that other examples may be used and that changes or alterations, such as structural changes, may be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into subcomputations with the same results.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code components and/or computer-executable instructions executed by one or more computers or processors, hardware, or some combination thereof. Some or all of the methods may alternatively be embodied in specialized computer hardware.

At least some of the processes discussed herein are illustrated as logical flow charts, each operation of which represents a sequence of operations that can be implemented in hardware, software, or a combination thereof. In the context of software, the operations represent computer-executable instructions stored on one or more non-transitory computer-readable storage media that, when executed by one or more processors, cause a computer or autonomous vehicle to perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions may be deleted or executed out of order from that shown or discussed, including substantially synchronously, in reverse order, with additional operations, or omitting operations, depending on the functionality involved as would be understood by those skilled in the art. Note that the term substantially may indicate a range. For example, substantially simultaneously may indicate that two activities occur within a time range of each other, substantially a same dimension may indicate that two elements have dimensions within a range of each other, and/or the like.

Many variations and modifications may be made to the above-described examples, the elements of which are to be understood as being among other acceptable examples. All such modifications and variations are intended to be included herein within the scope of this disclosure and protected by the following claims.

What is claimed is:

1. A system comprising
one or more processors; and
one or more non-transitory computer-readable media storing instructions executable by the one or more processors, wherein the instructions, when executed, cause the system to perform operations comprising:
obtaining, visual data acquired by a first image sensor and associated with a traffic scene;
obtaining, audio data acquired by a first audio sensor and associated with the traffic scene, wherein the first audio sensor and the first image sensor are mutually independent;
determining, based at least in part on the visual data and the audio data, embeddings for the traffic scene that represent a joint representation space for the different modalities; and
determining, by a first machine learning model, and based at least in part on the embeddings, presence of an emergency vehicle in the traffic scene.

2. The system of claim 1, wherein the instructions, when executed, cause the system to perform operations further comprising:
obtaining, range data acquired by a first range sensor and associated with the traffic scene, wherein the range sensor is a radar sensor or a lidar sensor; and
determining, based at least in part on the range data, the embeddings.

3. The system of claim 1, wherein the instructions, when executed, cause the system to perform operations further comprising:
labeling, based at least in part on at least one of the embeddings or determining presence of an emergency vehicle, the visual data thereby providing labeled visual data; and
training, based at least in part on the labeled visual data, a second machine learning model configured to accept at least visual data as input to detect emergency vehicles in traffic scenes.

4. The system of claim 1, wherein the instructions, when executed, cause the system to perform operations further comprising:
labeling, based at least in part on at least one of the embeddings or determining presence of an emergency vehicle, the audio data thereby providing labeled audio data; and
training, based at least in part on the labeled audio data, a third machine learning model configured to accept at least audio data as input to detect emergency vehicles in traffic scenes.

5. The system of claim 1, wherein the instructions, when executed, cause the system to perform operations further comprising:
controlling, based at least in part on determining presence of an emergency vehicle in the traffic scene, operation of an autonomous vehicle.

6. A method comprising:
obtaining, first sensor data acquired by a first sensor and associated with a traffic scene;
obtaining, second sensor data acquired by a second sensor and associated with the traffic scene, wherein the first sensor and the second sensor are mutually independent and of different modalities;
determining, based at least in part on the first sensor data and the second sensor data, embeddings for the traffic scene that represent a joint representation space for the different modalities; and
labeling, based at least in part on the embeddings, at least one of the first sensor data or the second sensor data thereby providing labeled sensor data.

7. The method of claim 6, further comprising:
training, based at least in part on the labeled sensor data, a second machine learning model configured to detect objects of a specific type in traffic scenes, wherein an accepted modality of the second machine learning model is at least a modality of the labeled sensor data, and the objects of the specific type are emergency vehicles.

8. The method of claim 6, wherein the second sensor is an audio sensor.

9. The method of claim 6, wherein the first sensor is one of an optical sensor or a radar sensor.

10. The method of claim 6, wherein the first sensor is an image sensor, the second sensor is an audio sensor and the method further comprises:
obtaining, range data acquired by a third sensor and associated with the traffic scene, wherein the third sensor is a radar sensor or lidar sensor; and
determining, and based at least in part on the range data, the embeddings.

11. The method of claim 6, further comprising:
obtaining, additional data acquired by an additional sensor and associated with the traffic scene, wherein the additional data is of the same modality as one of the first sensor data or the second sensor data and wherein the additional sensor is independent from the first sensor and the second sensor; and
determining, based at least in part on the additional data, the embeddings.

12. The method of claim 6, further comprising:
obtaining previously labeled sensor data, wherein the previously labeled data is audio data and/or visual data labeled by a second or third machine learning model;
labeling, based at least in part on the embeddings, the previously labeled data, thereby providing relabeled sensor data;
comparing labels of the previously labeled data to labels of the relabeled sensor data; and
training, based at least in part on the comparison, one or more of the second or third machine learning models.

13. The method of claim 6, further comprising:
determining, by a first machine learning model, and based at least in part on the embeddings, presence of an object of a specific type in the traffic scene.

14. The method of claim 13 wherein the first machine learning model is configured to detect presence of one or more emergency vehicles, accidents, ice cream trucks, electric vehicles, high-performance vehicles, motorcycles, heavy-duty trucks, military vehicles or rail crossings.

15. The method of claim 13, further comprising:
labeling, based at least in part on determining presence of the object of the specific type, the at least one of the first sensor data or the second sensor data.

16. The method of claim 13, further comprising:
training, based at least in part on ground truth data of different modalities associated with the same traffic scene, the first machine learning model; and
training, based at least in part on ground truth data of a single modality associated with a traffic scene, the first machine learning model.

17. The method of claim 13, further comprising:
controlling, based at least in part on determining presence of objects of the specific type in the traffic scene, operation of an autonomous vehicle.

18. One or more non-transitory computer-readable media storing instructions executable by one or more processors, wherein the instructions, when executed, cause the one or more processors to perform operations comprising:
obtaining, first sensor data acquired by a first sensor and associated with a traffic scene;
obtaining, second sensor data acquired by a second sensor and associated with the traffic scene, wherein the first sensor and the second sensor are mutually independent and of different modalities;
determining, based at least in part on the first sensor data and the second sensor data, embeddings for the traffic scene that represent a joint representation space for the different modalities; and
labeling, based at least in part on the embeddings, at least one of the first sensor data or the second sensor data thereby providing labeled sensor data.

19. The non-transitory computer-readable media of claim 18, wherein the instructions, when executed, cause the one or more processors to perform operations further comprising:
training, based at least in part on the labeled sensor data, a second machine learning model configured to detect objects of a specific type in traffic scenes, wherein an accepted modality of the second machine learning model is at least a modality of the labeled sensor data, and the objects of the specific type are emergency vehicles.

20. The non-transitory computer-readable media of claim 18, wherein the instructions, when executed, cause the one or more processors to perform operations further comprising:
determining, by a first machine learning model, and based at least in part on the embeddings, presence of an object of a specific type in the traffic scene.
